(19) United States
(12) Patent Application Publication
(10) Pub. No.: US 2010/0025213 A1
(43) Pub. Date: Feb. 4, 2010

(54) Key structure

(75) Inventor: Po Hsin Li, Taipei Hsein (TW)

Correspondence Address: BACON & THOMAS, PLLC, 625 SLATERS LANE, FOURTH FLOOR, ALEXANDRIA, VA, 22314-1176, US

(73) Assignee: CHICONY ELECTRONICS CO., LTD., Taipei Hsien (TW)

(21) Appl. No.: 12/453,848

(22) Filed: May 26, 2009

(30) Foreign Application Priority Data
Jul. 30, 2008 (TW) 97128742

(51) Int. Cl. H01H 13/02

(52) U.S. Cl. 200/344

(57) ABSTRACT

The object of the present invention is to provide a key structure in which the first pivot axis and the second pivot axis of the supporting element are pivotally coupled with the base and the keycap respectively, the end of the stabilizer bar stored in the base, and the third pivot axis of the stabilizer bar pivotally coupled with the keycap. With the supporting element, the stabilizer bar and the elastic member, the keycap can move upward and downward with respect to the base. As the design or arrangement of the supporting element and the stabilizer bar is simplified, the assembly of the keyboard becomes easier, so that the manufacturing costs of the keyboard can be effectively reduced. Moreover, the supporting element is made of plastics and produced by molding, thus the manufacturing costs can be further reduced. Additionally, when the user presses the key structure of the present invention, the noise generated due to the collision of the supporting element and the stabilizer bar with other parts in a prior art key structure will not occur.

### BACKGROUND OF THE INVENTION

1. Field of the Invention

The present invention relates to a key structure, and more particularly, to a key structure that generates no noise and features easy assembly construction and lower production costs.

2. Description of the Related Art

With the popularity of computer, users not only pursue better computer efficiency but also pay more attention to the function and design of computer accessories such as mouse and keyboard. As computer has become an indispensable device in nearly every aspect of modern life from telecommunication, commerce, editing to graphics design, mouse is definitely one of the most important input devices among computer peripheral equipments.

FIG. 1 and FIG. 2 show the exploded view and the schematic cross-sectional view of a prior art key structure respectively. A first stabilizer bar 1 and a second stabilizer bar 2 are set between a base 3 and a keycap 4. The first stabilizer bar 1 comprises a first end 5 and a first pivot axis 6; the base 3 opposite to the first end 5 of the first stabilizer bar 1 is equipped with a cavity 7, and the keycap 4 opposite to the first pivot axis 6 of the first stabilizer bar 1 is provided with at least a tenon 8. The first end 5 of the first stabilizer bar 1 is received by the cavity 7 disposed on the base 3 while the first pivot axis 6 of the first stabilizer bar 1 is fastened into the tenon 8 of the keycap 4.

The second stabilizer bar 2 includes a second end 9 and a second pivot axis 10; the base 3 opposite to the second end 9 of the second stabilizer bar 2 is equipped with an opening 11, and the keycap 4 opposite to the second pivot axis 10 of the second stabilizer bar 2 is equipped with a clutch means 12. The second end 9 of the second stabilizer bar 2 is inserted into the opening 11 of the base 3 while the second pivot axis 10 of the second stabilizer bar 2 is fastened into the clutch means 12 of the keycap 4.

Furthermore, an elastic member 13 is set between the base 3 and the keycap 4. With the first stabilizer bar 1, the second stabilizer bar 2 and the elastic member 13, the keycap 4 can move upward and downward with respect to the base 3. However, in the prior art technology, noise will be generated when the user presses the keycap 4 as the first stabilizer bar 1 will collide with the first holder 14 and the second stabilizer bar 2 will collide with the second holder 15 due to the way the two stabilizer bars are arranged. Moreover, the second end 9 of the second stabilizer bar 2 has to be manually inserted into the opening 11 of the base 3 accurately, thus the assembly process is not only time consuming but also increases the manufacturing costs. In addition, the width of the second stabilizer bar 2 (as the double-headed arrow “a” shown in FIG. 1) is subject to the size of the diameter of the elastic member 13 (the smaller the diameter of the elastic member the less elastic the elastic member), thus the reduction range of the width “a” is limited. Consequently, the extent of the size reduction of the first stabilizer bar 1, the second stabilizer bar 2, the base 3 and the keycap 4 is very limited. The prior art keyboard still has many drawbacks to be addressed.

The key structure that generates no noise and features lower costs comprises a base, a keycap set on the base, a supporting element which has a first pivot axis pivotally coupled with the base and a second pivot axis pivotally coupled with the keycap and is set between the base and the keycap, a stabilizer bar which has an end stored in the base and a third pivotal axis pivotally coupled with the keycap and is set between the base and the keycap, and an elastic member set between the base and the keycap. With the supporting element, the stabilizer bar and the elastic member, the keycap can move upward and downward with respect to the base.

It is preferable that the base opposite to the first pivot axis of the supporting element is equipped with a first clutch means to receive the first pivot axis of the supporting element.

It is preferable that the keycap opposite to the second pivot axis of the supporting element is equipped with a second clutch means to receive the second pivot axis of the supporting element.

It is preferable that the base opposite to the end of the stabilizer bar is equipped with a cavity to house the end of the stabilizer bar.

It is preferable that the keycap opposite to the third pivot axis of the stabilizer bar is equipped with a tenon to receive the third pivot axis of the stabilizer bar.

It is preferable that the base is equipped with a first opening to receive the elastic member.

It is preferable that the supporting element is provided with a second opening for the elastic member to pass through.

It is preferable that the keycap opposite to the elastic member is provided with a projection that touches the elastic member.

It is preferable that the elastic member further includes a ring-shaped member and the supporting element opposite to the ring-shaped member of the elastic member is equipped with a concave portion to house the ring-shaped member.

### BRIEF DESCRIPTION OF THE DRAWINGS

FIG. 1 is an exploded view of a prior art key structure.

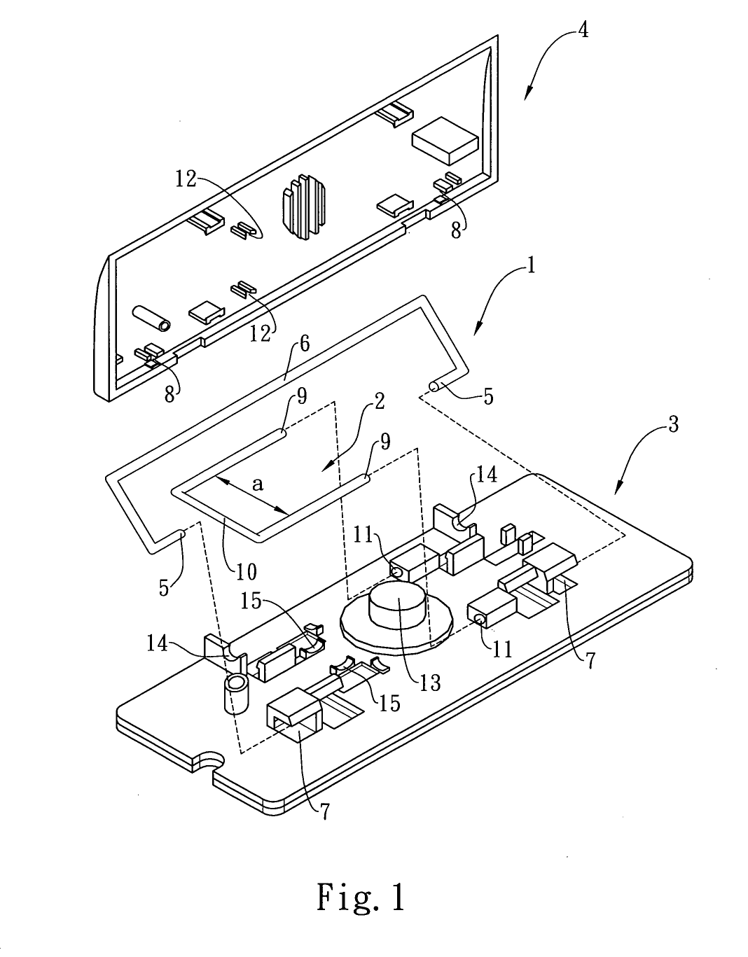

FIG. 2 is a schematic cross-sectional view of a prior art key structure.

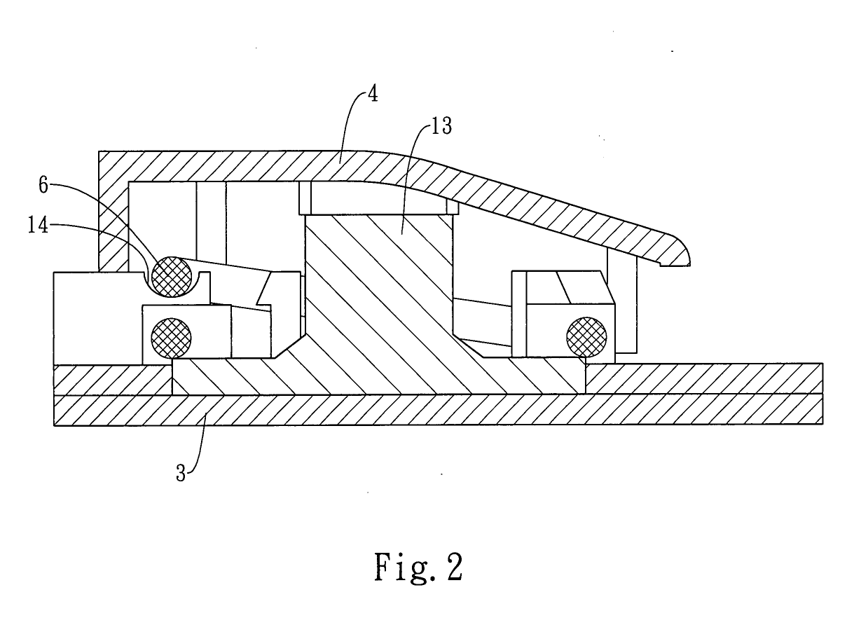

FIG. 3 is an exploded view of a key structure of the present invention.

FIG. 4 is a schematic cross-sectional view of a key structure of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

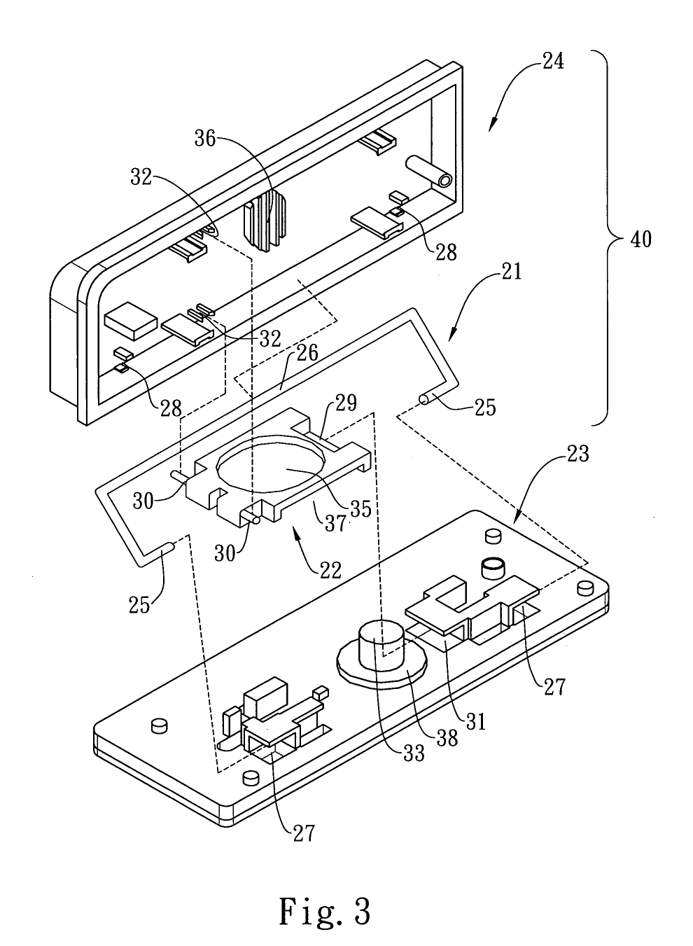

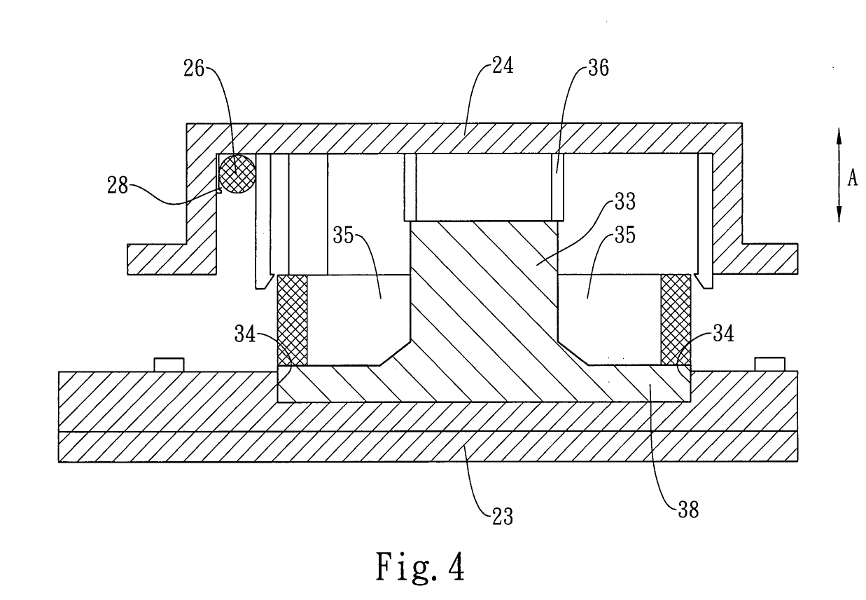

FIG. 3 and FIG. 4 show the exploded view and the schematic cross-sectional view of the key structure 40 of the present invention respectively. The key structure 40 of the present invention is applied in a keyboard, and the top and bottom casings of the keyboard are omitted to simplify the drawings.

The key structure 40 of the present invention includes a base 23, a keycap 24 set on the base 23, a supporting element 22 which has a first pivot axis 29 pivotally coupled with the base 23 and a second pivot axis 30 pivotally coupled with the keycap 24 on both corresponding sides and is set between the base 23 and the keycap 24, a stabilizer bar 21 that comprises an end 25 received by the base 23 and a third pivot axis 26 pivotally coupled with the keycap 24 and is set between the base 23 and the keycap 24, and an elastic member 33 set between the base 23 and the keycap 24.

The base 23 opposite to the first pivot axis 29 of the supporting element 22 is provided with a first clutch means 31 to receive the first pivot axis 29 of the supporting element 22. The keycap 24 opposite to the second pivot axis 30 of the supporting element 22 is provided with a second clutch means 32 to receive the second pivot axis 30 of the supporting element 22. In addition, the elastic member 33 further includes a ring-shaped member 38, and the supporting element 22 opposite to the ring-shaped member 38 of the elastic member 33 is equipped with a concave portion 37 to house the ring-shaped member 38 of the elastic member 33. Such a design enables the size of the supporting element 22 to be reduced.

The base 23 opposite to the end 25 of the stabilizer bar 21 is equipped with a cavity 27 to receive the end 25 of the stabilizer bar 21. The keycap 24 opposite to the third pivot axis 26 of the stabilizer bar 21 is equipped with a tenon 28 to receive the third pivot axis 26 of the stabilizer bar 21.

The base 23 is provided with a first opening 34 to house the bottom of the elastic member 33 while the supporting element 22 is equipped with a second opening 35 for the elastic member 33 to penetrate through. In addition, the keycap 24 opposite to the elastic member 33 is equipped with a projection 36 that touches the top surface of the elastic member 33.

As the first pivot axis 29 and the second pivot axis 30 of the supporting element 22 are pivotally coupled with the first clutch means 31 of the base 23 and the second clutch means 32 of the keycap 24 respectively, the end 25 of the stabilizer bar 21 received by the cavity 27 of the base 23, the third pivotal axis 26 of the stabilizer bar 21 pivotally coupled with the tenon 28 of the keycap 24 and the elasticity provided by the elastic member 33, the keycap 24 can move upward and downward with respect to the base 23 when the user presses the key structure 40 of the present invention (as the double-headed arrow “A” shown in FIG. 4).

The strengths of the present invention are as follows. As the design or arrangement of the supporting element and the stabilizer bar is simplified, the assembly of the key structure becomes easier, and thus the manufacturing costs of the keyboard can be effectively reduced. Moreover, the noise problem caused by the collision of the supporting element and the stabilizer bar with other parts will not occur when the user presses the key structure of the present invention.

While this invention has been described by way of examples and in terms of preferred embodiments, it is to be understood that this invention is not limited hereto, and that various changes, substitutions, and alterations can be made herein without departing from the spirit and scope of this invention as defined by the appended claims. Please refer to the claims for the coverage of the rights of the present invention.

What is claimed is:

1. a key structure, including:
a base;
a keycap set on said base;
a supporting element that has a first pivot axis pivotally coupled with said base and a second pivot axis pivotally coupled with said keycap and is set between said base and said keycap;
a stabilizer bar that has an end received by said base and a third pivot axis pivotally coupled with said keycap and is set between said base and said keycap; and
an elastic member set between said base and said keycap;
wherein, said keycap can move upward and downward with respect to said base through said supporting element, said stabilizer bar and said elastic member.

2. The key structure according to claim 1, wherein said base opposite to said first pivot axis of said supporting element is equipped with a first clutch means to receive said first pivot axis of said supporting element.

3. The key structure according to claim 1, wherein said keycap opposite to said second pivot axis of said supporting element is equipped with a second clutch means to receive said second pivot axis of said supporting element.

4. The key structure according to claim 1, wherein said base opposite to said end of said stabilizer bar is provided with a cavity to house said end of said stabilizer bar.

5. The key structure according to claim 1, wherein said keycap opposite to said third pivot axis of said stabilizer bar is equipped with a tenon to receive said third pivot axis of said stabilizer bar.

6. The key structure according to claim 1, wherein said base is equipped with a first opening to receive said elastic member.

7. The key structure according to claim 1, wherein said supporting element is equipped with a second opening for said elastic member to pass through and then connect with said keycap.

8. The key structure according to claim 7, wherein said keycap opposite to said elastic member is provided with a projection that touches said elastic member.

9. The key structure according to claim 1, wherein said elastic member further includes a ring-shaped member, and said supporting element opposite to said ring-shaped member of said elastic member is equipped with a concave portion to receive said ring-shaped member.
